(19) United States
(12) Patent Application Publication
(10) Pub. No.: US 2026/0116448 A1
(43) Pub. Date: Apr. 30, 2026

(54) FOLDABLE STORAGE CONTAINER

(71) Applicant: Great Star Tools USA, Inc., Saddle Brook, NJ (US)

(72) Inventor: Hui YAN, Hangzhou City (CN)

(21) Appl. No.: 18/930,267

(22) Filed: Oct. 29, 2024

(51) Int. Cl. B62B 3/02; B62B 3/00; B62B 5/06

(52) U.S. Cl. CPC B62B 3/022; B62B 3/003; B62B 3/004; B62B 5/067

(57) ABSTRACT

The present invention aims to overcome the problem of increased transportation cost arising from the unfoldability of conventional storage boxes for use at construction sites, by disclosing a foldable storage container. The present invention solves the problem by comprising a bottom wall and a top wall, the bottom wall hinged to first side walls and second side walls; both the first side walls and the second side walls are provided in two, and disposed in opposition at two sides of the bottom wall, the first side walls hinged to the top wall, the second side walls each comprising a number of inter-hinged side-wall individual plates, wherein when in a folded configuration, the side-wall individual plates are folded and the first side walls and the second side walls are folded by being pivoted about their edges, where they are hinged to the bottom wall, and stowed between the top wall and the bottom wall. According to this application, when there is need for transportation, the first side walls and the second side walls can be folded toward the bottom wall, thereby converting the overall structure into the folded configuration, where it has a reduced overall size and occupies a smaller space during transportation, resulting in transportation cost savings.

### FIELD OF THE INVENTION

The present invention relates to the field of storage boxes for use at construction sites and, in particular, to a foldable storage container.

### DESCRIPTION OF THE PRIOR ART

Storage boxes are often used at construction sites as means for storing a variety of tools, hardware and devices. Existing boxes are usually supported with heavy duty steel and cannot be folded. Therefore, they occupy a large space during transportation, resulting in increases in transportation cost.

### SUMMARY OF THE INVENTION

The present invention overcomes the problem of increased transportation cost arising from the unfoldability of conventional storage boxes for use at construction sites, by presenting a foldable storage container for use at construction sites, which can be folded during transportation and thus results in transportation cost savings.

To this end, the present invention lies in a foldable storage container comprising a bottom wall and a top wall, the bottom wall hinged to first side walls and second side walls; both the first side walls and the second side walls are provided in two, and disposed in opposition at two sides of the bottom wall; the second side walls hinged to the top wall, the second side walls each comprising a number of inter-hinged side-wall individual plates, wherein when in a folded configuration, the side-wall individual plates are folded and the first side walls and the second side walls are folded by being pivoted about their edges, where they are hinged to the bottom wall, and stowed between the top wall and the bottom wall.

According to the present application, when there is need for transportation, the first side walls and the second side walls can be folded toward the bottom wall, thereby converting the overall structure into the folded configuration, where it has a reduced overall size and occupies a smaller space during transportation, resulting in transportation cost savings. When there is a need for unfolding, the top wall is directly pulled upwards so that the second side walls become upright, and the first side walls are then unfolded so as to also become upright. Connecting means are then used to join and secure the first side walls and the second side walls together, completing the assembly of the whole structure. This provides the advantage of convenient assembly.

Preferably, the first side walls are hinged at their first edges to the bottom wall and the second side walls are hinged at their second edges to the bottom wall, wherein the first edges are spaced from the bottom wall at a vertical height of H1, the second edges are spaced from the bottom wall at a vertical height of H2, the first side walls have a thickness of D, and H2−H1 D.

Since H2−H1≥D, in the folded configuration, the first side walls are folded onto the bottom wall so as to lie under H2, i.e., under the second edges. This can avoid them from affecting folding of the second side walls and result in an even smaller overall size in the folded configuration.

Preferably, the bottom wall is provided at the bottom with a number of seat sleeves and a number of detachable roller wheels, the seat sleeves arranged along the two sides opposing in a widthwise direction of the bottom wall.

With this arrangement, two forks of a forklift can be inserted through the seat sleeves disposed along the two sides opposing in the widthwise direction so that the center of gravity of the foldable storage container is located between the two forks of the forklift during transfer, enabling more stable transfer of the foldable storage container. Prior to transportation, the detachable roller wheels can be removed from the bottom of the bottom wall and placed within the seat sleeves or between the bottom and top walls, additionally reducing the overall size.

Preferably, the seat sleeves each comprise a first plate provided at opposite ends thereof respectively with a second plate and a third plate, wherein the roller wheels are detachably disposed at the bottom of the first plates.

Disposing the roller wheels at the bottom of the first plates means that the bottom wall has a height equal to the sum of the heights of the roller wheels and the seat sleeves. This enables the foldable storage container to have a floor with an increased overall height. The environments of construction sites are harsh and mostly have uneven ground. Arranging the roller wheels at the bottom of the first plates enables the foldable storage container to have a floor with an increased height, which can facilitate travel of the foldable storage container at such construction sites.

Preferably, the first plates are disposed close to side edges of the bottom wall opposing in the widthwise direction and inclined toward the side edges of the bottom wall.

Arranging the seat sleeves at the two sides of the bottom wall opposing in the widthwise direction means that the first plates in these seat sleeves are flared, as a whole, at the opposite sides of the bottom wall. This enables the seat sleeves on the bottom wall to stably support the foldable storage container and increase overall strength of the side walls.

Preferably, the top wall comprises an upper securing frame and an upper cover, the upper cover hinged at a side edge on its one side to the securing frame.

With this arrangement, the upper cover can be pivoted about its hinged edge to open and close the foldable storage container as desired.

Preferably, a support strut is provided between the upper securing frame and the upper cover and is connected to the upper securing frame at one end and to the upper cover at the other end.

Examples of the support strut may include, but are not limited to, a hydraulic buffer strut. The hydraulic buffer strut is connected to an inner surface of the upper securing frame at one end and to the upper cover at the other end. During opening of the upper cover, due to a heavy weight, it may suddenly slam down and close under the effect of gravity, possibly dangerously clamping the operating worker's hand. In order to avoid this, the hydraulic buffer strut is provided to buffer and resist closing of the upper cover and thereby allow the upper cover to close slowly, preventing said danger.

Preferably, the upper securing frame are provided in its side wall with inwardly depressed locking recesses, on top of which there are locking plates defining locking slots extending therethrough, wherein the upper cover is provided with locking tongues in cooperation with the locking slots.

When the upper cover is closed, the locking tongue can exactly pass through the locking slot. The locking tongue may define an end eyelet, through which locking means can be inserted to lock the upper cover and the upper securing frame against each other.

Preferably, the upper securing frame comprises two second widthwise bars and two second lengthwise bars, the two second widthwise bars disposed in opposition, the two second lengthwise bars also disposed in opposition, the two second lengthwise bars hinged to top ends of two second side walls, respectively, the second lengthwise bars having a greater height than the second widthwise bars.

With this arrangement, the first side walls can be unfolded so that their upper end portions are exactly located between the two second lengthwise bars. Thus, the second lengthwise bars can restrict the top end portions of the first side walls, making the resulting box in the unfolded configuration more structurally stable.

Preferably, the second widthwise bars are each provided with a mounting protrusion having a number of mounting threaded holes arranged in a vertical row, wherein the upper cover is provided on its inner side with an inner cover plate, and the two ends of the support strut are respectively connected to the mounting threaded holes and the inner cover plate.

Providing the mounting threaded holes in a vertical row means the mounting threaded holes being spaced from the inner cover plate at difference distances. Accordingly, selectively connecting the support strut to the mounting threaded holes enables the support strut to have different initial lengths, which result in different resistance that the upper cover encounters during its closure.

Preferably, the support strut is a hydraulic buffer strut comprising an oil cylinder and a piston rod movable at one end within the oil cylinder.

Resistance to movement of the piston rod in the oil cylinder can provide support to the upper cover, preventing its sudden closure under the action of gravity, which may injure fingers of an operator.

Preferably, the bottom wall comprises a lower securing frame and a lower cover fixedly connected to the lower securing frame, the lower securing frame comprising two first widthwise bars and two first lengthwise bars, the two first widthwise bars disposed in opposition, the two first lengthwise bars disposed in opposition, the first widthwise bars hinged to the first side walls, the first lengthwise bars hinged to the second side walls, the first lengthwise bars having a greater height than the first widthwise bars.

With this arrangement, the first side walls can be folded onto the bottom wall so that their upper end faces are lower than upper end faces of the first lengthwise bars, without affecting folding of the second side walls.

Preferably, the first side walls each have an inwardly depressed side-wall recess, in which a handle is rotatably disposed.

The handles can facilitate pushing and pulling of the foldable storage container.

Preferably, rotating shafts are disposed at two ends of the side-wall recess opposing in a widthwise direction of the first side wall, wherein opposite sides of the handle are rotatably coupled to the rotating shafts at said two ends, respectively.

Within the side-wall recesses, the handles are vertically oriented under the effect of gravity without protruding beyond the end faces of the first side wall. This enables an even smaller overall size in the folded configuration.

Preferably, a securing structure is provided between the top and bottom walls to secure them against each other in the folded configuration of the box to limit their relative displacement.

In the folded configuration of the box, the securing structure can be used to secure the top and bottom walls against each other, thereby limiting their relative displacement. This can reduce vibration of the box, relative displacement of the top and bottom walls, noise due to movement and damage due to vibration, during transportation and transfer of the box in the folded configuration.

Preferably, the securing structure comprises a rotatable plate and a securing pin, which are disposed on the top wall and the bottom wall, respectively, the rotatable plate having a hook portion at its end away from a center of rotation.

After the box is folded, the rotatable plate can be pivoted to hook the securing pin with the hook portion. A length of the rotatable plate corresponds to a distance between the upper securing frame and the lower securing frame in the folded configuration of the box. With the hook portion hooking the securing pin, the top and bottom walls are secured against each other during transportation of the box. In this way, during transportation and transfer, less relative displacement will occur between the top and bottom walls and the folded box stays more stably.

Preferably, connecting structures are provided between the first side walls and the top wall to temporarily secure the first side walls against the second side walls or the top wall in an unfolded configuration of the box.

Such connecting structures may be provided between the first side walls and the top wall or the second side walls, and may be used to temporarily secure the first side walls against the top wall in the unfolded configuration of the box. In order to fold the box, the connecting structures can be disconnected, allowing separation of the first side walls and the top wall. Thus, the box can be conveniently folded.

Preferably, the connecting structures each comprise a connecting plate and a locking plate, which are arranged on the top wall and the first side walls, respectively, the locking plate defining an open channel, the connecting plate able to be pivoted and adapted to the open channel.

The connecting plates can be engaged and restricted in the open channel, thereby connecting the first side walls to the top wall. When the connecting plates are disengaged from the open channels, the first side walls can be pivoted freely for folding.

Preferably, the locking plate is located under the connecting plate.

Under the action of gravity, the connecting plates remain vertically oriented. During use, except for manual intervention, the connecting plates will not disengage from the open channels, ensuring that the box is always kept unfolded without affecting normal use. Only when the box is to be folded, the connecting plates can be manually pivoted away and disengaged from the open channels to allow the box to be folded.

Preferably, the connecting plate defines a bent tab at its end away from a center of rotation.

The bent tabs enable more stable engagement of the connecting plates in the open channels.

The present invention has the following advantages over the prior art:
(1) According to the present application, when there is need for transportation, the first and second side walls can be folded toward the bottom wall, thereby converting the overall structure into the folded configuration, where it has a reduced overall size and occupies a smaller space during transportation, resulting in transportation cost savings.
(2) When there is a need for unfolding, the top wall is directly pulled upwards so that the second side walls become upright, and the first side walls are then unfolded so as to also become upright. Connecting means are then used to join and secure the first and second side walls together, completing the assembly of the whole structure. This provides the advantage of convenient assembly.
(3) Providing each second side wall in the form of a number of inter-hinged side-wall individual plates, which can be folded together, enables an even smaller size in the folded configuration.
(4) Prior to transportation, the detachable roller wheels can be removed from the bottom of the bottom wall and placed within the seat sleeves or between the bottom and top walls, thereby additionally reducing the overall size and hence transportation cost.
(5) The inwardly depressed locking recesses in the side face of the upper securing frame can additionally reduce the size in the folded configuration and hence transportation cost.
(6) Under the action of gravity, the handles are vertically oriented in the side-wall recesses without protruding beyond the end faces of the first side walls. In the folded configuration, the handles are received within the side-wall recesses, further reducing the overall size of the folded box.
(7) During handling of the foldable storage container, for example, forks of a forklift can be conveniently inserted through the seat sleeves, dispensing with the use of an associated forklift pallet and thus enabling more efficient transfer of the foldable storage container.
(8) Disposing the roller wheels at the bottom of the first plates enables the foldable storage container to have a floor with an increased overall height, which facilitate travel of the foldable storage container at construction sites.
(9) The securing structure can reduce vibration of the box, relative displacement of the top and bottom walls, noise due to movement and damage due to vibration, during transportation and transfer of the box in the folded configuration.
(10) The connecting structures can be used to temporarily secure the first side walls against the top wall in the unfolded configuration of the box. In order to fold the box, the connecting structures can be disconnected, allowing separation of the first side walls and the top wall. Thus, the box can be conveniently folded.

### BRIEF DESCRIPTION OF DRAWINGS

FIG. 1 is a perspective structural view of the present invention.

FIG. 2 is a side view of the present invention.

FIG. 3 is an exploded view of the present invention.

FIG. 4 shows a configuration of the present invention with an upper cover being opened.

FIG. 5 is a perspective structural view of the present invention in a folded configuration.

FIG. 6 is an exploded view of the present invention in the folded configuration.

FIG. 7 is a schematic diagram of the present invention in the folded configuration, showing roller wheels being stowed in seat sleeves.

FIG. 8 is a schematic diagram of the present invention in the folded configuration, showing the roller wheels being placed between top and bottom walls.

FIG. 9 is a schematic diagram of the present invention in the folded configuration, showing the roller wheels being placed between side-wall individual plates and the top wall.

FIG. 10 is an exploded view of the present invention, showing a second side wall having three side-wall individual plates.

FIG. 11 is a schematic structural view of the present invention in the folded configuration, showing a rotatable plate being in engagement with a securing pin.

FIG. 12 is a schematic structural view of the present invention in the folded configuration, showing a connecting plate being in engagement with a locking plate.

### LIST OF REFERENCE NUMERALS

1 bottom wall, 11 lower securing frame, 111 first widthwise bar, 112 first lengthwise bar, 12 lower cover, 13 hydraulic buffer strut, 131 piston rod, 132 oil cylinder, 133 first threaded head, 134 second threaded head;
2 top wall, 21 upper securing frame, 211 second widthwise bar, 212 second lengthwise bar, 213 mounting protrusion, 214 mounting threaded hole, 215 locking recess, 216 locking tongue, 217 locking slot, 22 upper cover, 23 inner cover plate;
3 first side wall, 31 side-wall recess;
4 second side wall, 41 side-wall individual plate;
5 seat sleeve, 51 first plate, 52 second plate, 53 third plate;
6 roller wheel, 61 roller wheel brake, 62 mounting plate;
7 handle, 71 rotating shaft;
81 first reinforcing web, 82 second reinforcing web, 83 third reinforcing web, 84 fourth reinforcing web, 85 cable aperture;
91 rotatable plate, 911 hook portion, 92 securing pin, 93 connecting plate, 931 bent tab, 94 locking plate, 941 open channel.

### DETAILED DESCRIPTION OF THE PREFERRED EMBODIMENTS

The present invention will be described in greater detail below by way of specific examples with reference to the accompanying drawings.

### Example 1

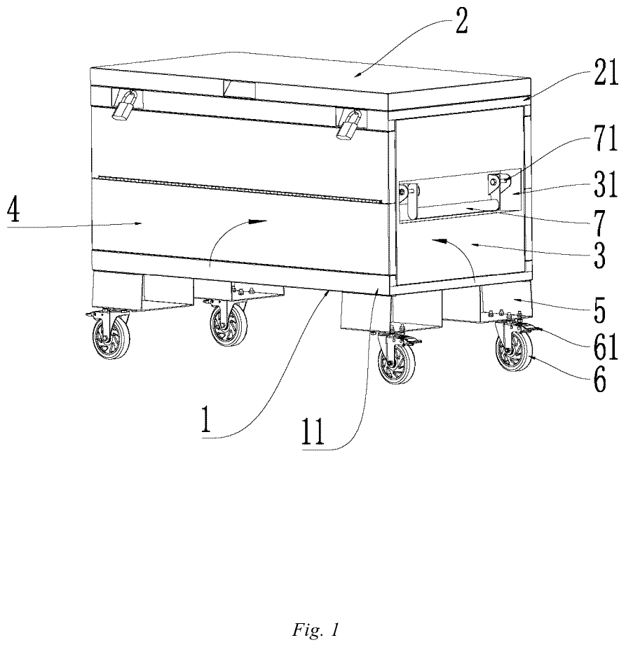

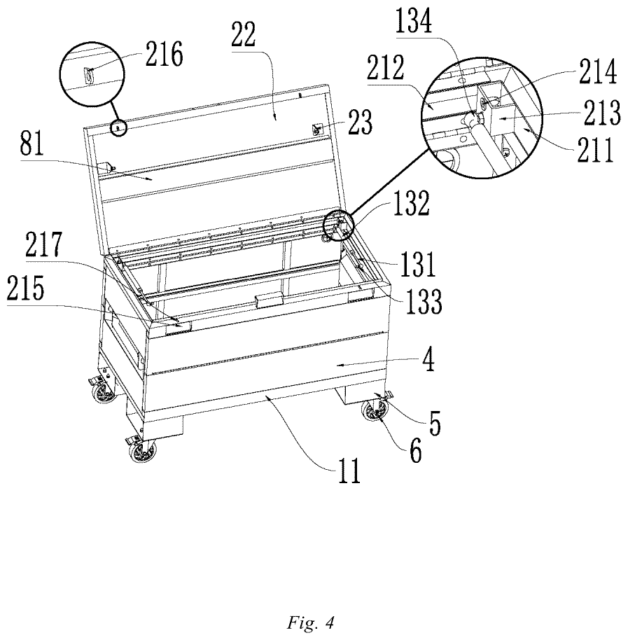

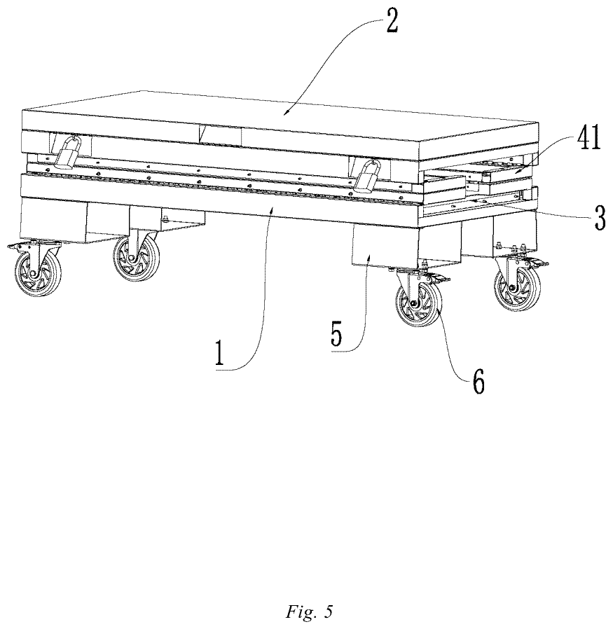

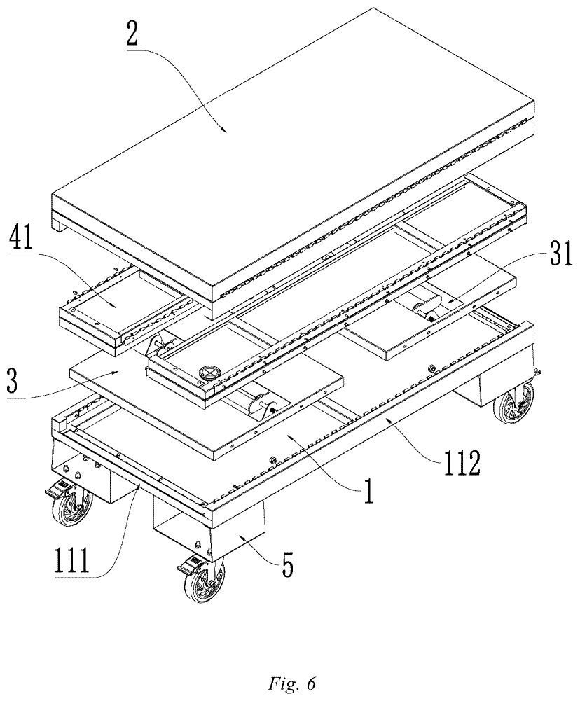

Referring to FIGS. 1 to 10, a foldable storage container includes a bottom wall 1 and a top wall 2. The bottom wall 1 is hinged to a pair of first side walls 3 and a pair of second side walls 4, which are each arranged at opposite sides of the bottom wall 1. The second side walls 4 are hinged to the top wall 2 and each include a number of inter-hinged side-wall individual plates 41. When in a folded configuration, the side-wall individual plates 41 are folded, and the first side walls 3 and the second side walls 4 are folded along their edges, where they are hinged to the bottom wall 1, and stowed between the top wall 2 and the bottom wall 1.

In this example, the bottom wall 1, the surrounding first and second side walls 3, 4 and the top wall 2 together form a box defining an interior storage space. The first side walls 3 and second side walls 4 are all hinged to the bottom wall 1 so as to be pivotable about the respective side edges of the bottom wall 1 and thereby foldable toward the bottom wall 1 (as indicated by the arrows in FIG. 1). In this way, the opposing second side walls 4 does not undesirably interfere with each other when in the folded configuration and each has a certain height when in an unfolded configuration, which enables the box to have an increased volume available for use. Particularly, providing each of the second side walls 4 in the form of a number of inter-hinged side-wall individual plates 41 allows the cavity to have an increased volume available for use when in the unfolded configuration where the side-wall individual plates 41 are unfolded to form the first side walls 3 that each have a relatively large height. Moreover, when in the folded configuration, the side-wall individual plates 41 can be folded together so that the folded second side walls 4 are each overall as wide as each single side-wall individual plate 41. Therefore, the two folded second side walls 4 are located at the opposite sides of the bottom wall 1 without mutual interference.

Unfolding the folded box is necessary before it can be used. Since the top wall 2 is hinged to the second side walls 4, in order to unfold the box, the top wall 2 can be simply pulled upwardly so that the second side walls 4 become upright and perpendicular to the bottom wall 1. After that, the first side walls 3 are unfolded so as to also become upright and perpendicular to the bottom wall 1. Connecting means are then applied to locations where the first side walls 3 and the second side walls 4 contact each other to secure them together, completing the assembly of the box.

Therefore, in this example, when there is a need for transportation, the first side walls 3 and the second side walls 4 may be folded toward the bottom wall 1, converting the whole into a folded configuration. As a result, a reduced overall size is obtained, which occupies a smaller space during transportation, resulting in transportation cost savings. When there is a need for unfolding, the top wall 2 is directly pulled upwards so that the second side walls 4 become upright, and the first side walls 3 are then unfolded so as to also become upright. Connecting means are then used to join and secure the first side walls 3 and the second side walls 4 together, completing the assembly of the whole structure. This provides the advantage of convenient assembly.

### Example 2

Referring to FIGS. 1 to 10, a foldable storage container includes a bottom wall 1 and a top wall 2. The bottom wall 1 is hinged to a pair of first side walls 3 and a pair of second side walls 4, which are each arranged at opposite sides of the bottom wall 1. The second side walls 4 are hinged to the top wall 2 and each include a number of inter-hinged side-wall individual plates 41. When in a folded configuration, the side-wall individual plates 41 are folded, and the first side walls 3 and the second side walls 4 are folded along their edges, where they are hinged to the bottom wall 1, and stowed between the top wall 2 and the bottom wall 1.

The first side walls 3 are arranged at two ends of the bottom wall 1, which oppose in a lengthwise direction of the bottom wall 1. The second side walls 4 are arranged at two ends of the bottom wall 1, which oppose in a widthwise direction of the bottom wall 1. The first side walls 3 have a shorter horizontal length than the second side walls 4.

The edges of the first side walls 3, where they are hinged to the bottom wall 1, are defined as first edges. The edges of the second side walls 4, where they are hinged to the bottom wall 1, are defined as second edges. The first edges are spaced from the bottom wall 1 at a vertical height of H1, and the second edges are spaced from the bottom wall 1 at a vertical height of H2. H2 is greater than H1. The first side walls 3 have a thickness of D, and H2−H1≥D. With this arrangement, when in a folded configuration, the first side walls 3 can be folded onto the bottom wall 1 so as to lie under H2, i.e., under the second edges, without affecting folding of the second side walls 4. In this way, an even smaller overall size can be obtained in the folded configuration.

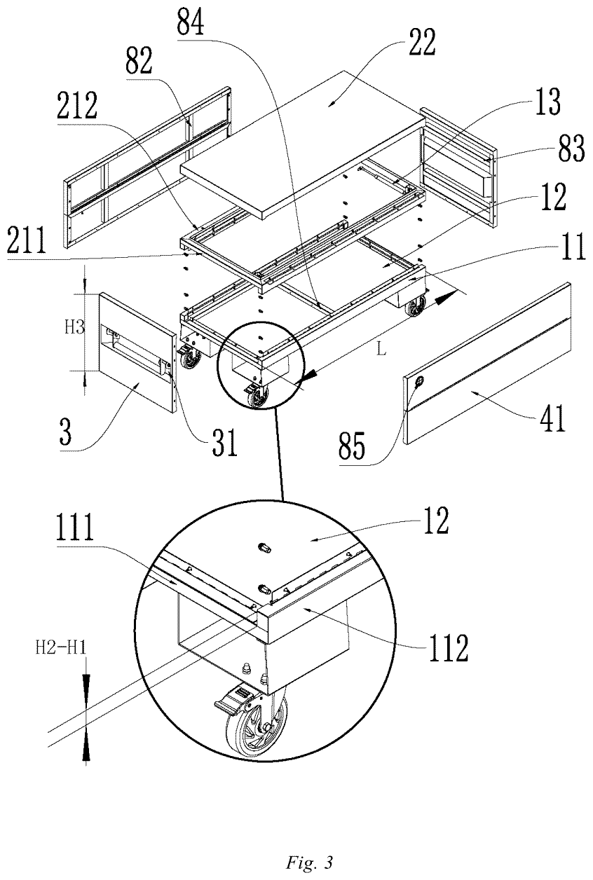

In addition, as shown in FIG. 3, in this example, the first side walls 3 are one-piece plates. Therefore, in the folded configuration, in order to prevent the first side walls 3 from interfering with each other during their folding onto the bottom wall 1, assuming that the first side walls 3 have a height of H3 and the bottom wall 1 has a length of L, then 2*H3≤L. In this way, the two first side walls 3 can be folded onto the bottom wall 1 at the sides thereof opposing in the lengthwise direction.

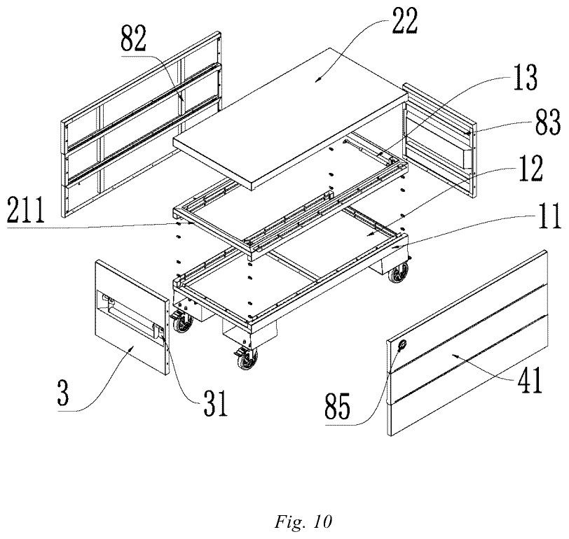

It is to be noted that the second side walls 4 can be folded so that the side-wall individual plates 41 in each of them are folded together. In this example, each second side wall 4 is made up of two inter-hinged side-wall individual plates 41, which can be folded together. Of course, depending on the actual circumstances, three (see FIG. 10), four or more side-wall individual plates 41 are also possible.

Providing each of the first side walls 3 as a number of inter-hinged side-wall individual plates 41 allows the first side walls 3 to have a large height when in an unfolded configuration where the side-wall individual plates 41 are unfolded to form a box, which ensures that the foldable storage container has a desired volume available for use in the unfolded configuration. Moreover, each set of side-wall individual plates 41 can be folded together so that the folded second side walls 4 are each overall as wide as each single side-wall individual plate 41. Therefore, the two folded second side walls 4 are located at the opposite sides of the bottom wall 1 without mutual interference.

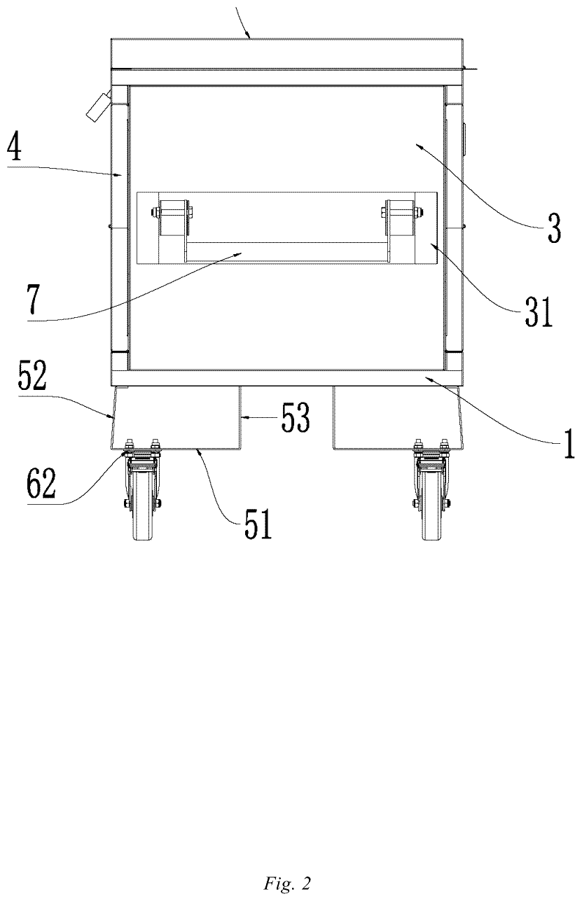

In order to enable the foldable storage container to be more conveniently moved during use and more conveniently transferred, for example, by a forklift, clamplift or a similar machine, as shown in FIG. 2, the bottom wall 1 is provided at the bottom with a number of seat sleeves 5 and detachable roller wheels 6. The seat sleeves 5 are arranged at the two sides of the bottom wall 1 opposing in the widthwise direction.

In this example, four seat sleeves 5 and four roller wheels 6 are provided. In particular, two of the seat sleeves 5 and two of the roller wheels 6 are provided at each of the two sides of the bottom wall 1 opposing in the widthwise direction.

During handling of the foldable storage container, forks of a forklift can be conveniently inserted through the seat sleeves 5, dispensing with the use of an associated forklift pallet and thus enabling more efficient transfer of the foldable storage container. The seat sleeves 5 can also function to support the foldable storage container. To this end, in order for more stable transfer of the foldable storage container by a forklift to be achieved, the seat sleeves 5 are provided at the two sides of the bottom wall 1 that oppose in the widthwise direction. In this way, the two forks of the forklift can be inserted through the respective sets of seat sleeves 5 disposed along the two sides opposing in the widthwise direction so that the center of gravity of the foldable storage container is located between the two forks of the forklift during transfer. This enables more stable transfer of the foldable storage container.

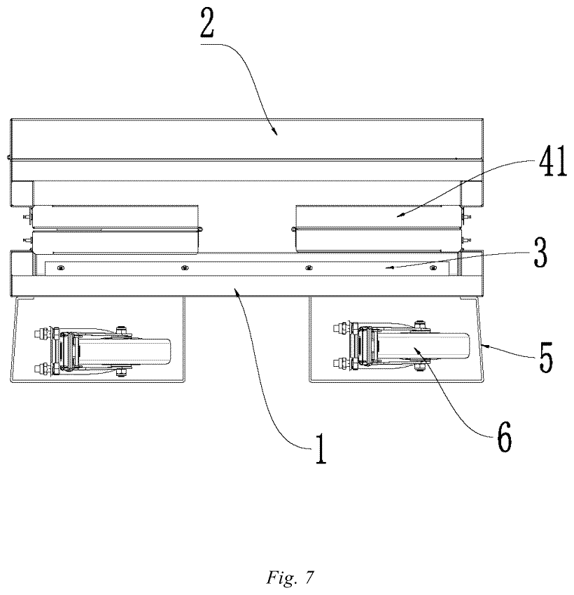

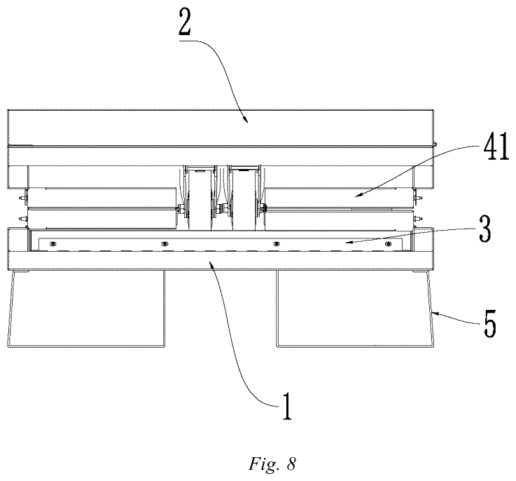

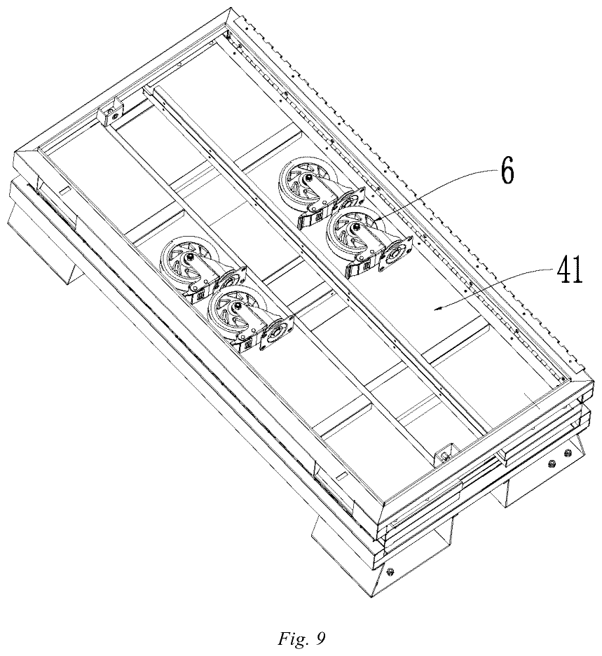

During transportation, the detachable roller wheels 6 may be detached from the bottom wall 1 and stowed within the seat sleeves 5 (see FIG. 7), or placed between the bottom wall 1 and the top wall 2 (see FIG. 8), or between the side-wall individual plates 41 and the top wall 2 (see FIG. 9), reducing the overall size. During use, they can be again mounted to the bottom wall 1 to facilitate movement of the foldable storage container in response to a push. Further, the roller wheels 6 may be provided with roller wheel brakes 61, which can lock the roller wheels 6 any time as desired to prevent movement of the box.

In one implementation, each seat sleeve 5 includes a first plate 51, as well as a second plate 52 and a third plate 53, which are separately disposed at opposite ends of the first plate 51. The roller wheels 6 are detachably attached to the bottom of the first plates 51. Mounting plates 62 are arranged on top of the roller wheels 6 and bolted to the first plates 51. In this way, the roller wheels 6 can be detachably coupled to the first plates 51. Alternatively, the roller wheels 6 may be directly attached to the bottom of the bottom wall 1, like the seat sleeves 5. However, in this example, the roller wheels 6 are arranged at the bottom of the first plates 51. Thus, the bottom wall 1 has a height equal to the sum of the heights of the roller wheels 6 and the seat sleeves 5. This enables the foldable storage container to have a floor with an increased overall height. The environments of construction sites are harsh and mostly have uneven ground. Arranging the roller wheels 6 at the bottom of the first plates 51 enables the foldable storage container to have a floor with an increased height, which can facilitate travel of the foldable storage container at such construction sites.

In order to increase overall structural stability, the first plates 51 are disposed adjacent to the side edges of the bottom wall 1 opposing in the widthwise direction and inclined toward said side edges of the bottom wall 1 (see FIG. 2). Since the seat sleeves 5 are disposed at the two sides of the bottom wall 1 opposing in the widthwise direction, the first plates 51 in these seat sleeves 5 are thus flared, as a whole, at the opposite sides of the bottom wall 1. In this way, the seat sleeves 5 on the bottom wall 1 can stably support the foldable storage container and increases overall strength of the side walls.

In one implementation, the top wall 2 and the bottom wall 1 are similar in structure. The bottom wall 1 includes a lower securing frame 11 and a lower cover 12. The lower cover 12 is fixedly coupled to the lower securing frame 11. The top wall 2 includes an upper securing frame 21 and an upper cover 22. One side edge on one side of the upper cover 22 is hinged to one side edge on one side of the upper securing frame 21. The side edge of the upper cover 22 that is hinged to the upper securing frame 21 is referred to as an upper-cover hinged edge, about which the upper cover 22 can be pivoted as desired to open and close the foldable storage container.

The lower securing frame 11 includes two first widthwise bars 111 and two first lengthwise bars 112. The two first widthwise bars 111 oppose each other, and the two first lengthwise bars 112 oppose each other. The first widthwise bars 111 are hinged to the first side walls 3, and the first lengthwise bars 112 are hinged to the second side walls 4. The first lengthwise bars 112 have a greater height than the first widthwise bars 111. As a result, the first side walls 3 can be folded onto the bottom wall 1 so that their upper end faces are lower than upper end faces of the first lengthwise bars 112, without affecting folding of the second side walls 4.

The upper securing frame 21 includes two second widthwise bars 211 and two second lengthwise bars 212. The two second widthwise bars 211 oppose each other, and the two second lengthwise bars 212 also oppose each other. The two second lengthwise bars 212 are hinged to top ends of the respective two second side walls 4, and the second lengthwise bars 212 have a greater height than the second widthwise bars 211. In this way, the first side walls 3 can be unfolded so that their upper end portions are exactly located between the two second lengthwise bars 212. Thus, the second lengthwise bars 212 can restrict the top end portions of the first side walls 3, making the resulting box in the unfolded configuration more structurally stable.

A support strut is provided between the upper securing frame 21 and the upper cover 22. Examples of the support strut may include, but are not limited to, a hydraulic buffer strut 13. The hydraulic buffer strut 13 is connected to an inner surface of the upper securing frame 21 at one end and to the upper cover 22 at the other end. During opening of the upper cover 22, due to a heavy weight, it may suddenly slam down and close under the effect of gravity, possibly dangerously clamping the operating worker's hand. In order to avoid this, the hydraulic buffer strut 13 is provided to buffer and resist closing of the upper cover 22 and thereby allow the upper cover 22 to close slowly, preventing said danger.

In order to enable more stable closure of the upper cover 22, two hydraulic buffer struts 13 may be provided, which are juxtaposed in a lengthwise direction of the upper cover 22 and extend in a widthwise direction of the upper cover 22.

In one implementation, the second widthwise bars 211 are each provided at the end proximate the upper-cover hinged edge with a mounting protrusion 213 defining a number of mounting threaded holes 214 rowed in the vertical direction. In this example, two mounting threaded holes 214 are defined. The hydraulic buffer strut 13 includes a piston rod 131 and an oil cylinder 132. One end of the piston rod 131 is movable within the oil cylinder 132, and the other end of the piston rod 131 away from the oil cylinder 132 defines a first threaded head 133. The end of the oil cylinder 132 away from the piston rod 131 defines a second threaded head 134. The upper cover 22 is provided on its inner side with an inner cover plate 23, and the second threaded head 134 is threadedly coupled to one of the mounting threaded holes 214. The first threaded head 133 is threadedly coupled to the inner cover plate 23. The mounting threaded holes 214 rowed in the vertical direction are spaced from the inner cover plate 23 at different distances. Selectively connecting the piston rod 131 to the mounting threaded holes 214 enables the upper cover 22 to encounter different resistance during its closure.

In a side wall of the upper securing frame 21 away from the upper-cover hinged edge, an inwardly depressed locking recess 215 is provided. A locking plate lies on top of the locking recess 215 and defines a locking slot 217 extending therethrough. The upper cover 22 has a locking tongue 216 for use in cooperation with the locking slot 217. When the upper cover 22 is closed, the locking tongue 216 can exactly pass through the locking slot 217. The locking tongue 216 defines an end eyelet, through which locking means can be inserted to lock the upper cover 22 and the upper securing frame 21 against each other. In this example, there are two locking recesses 215, two locking plates, two locking slots 217 and two locking tongues 216, which are arranged in a row in a lengthwise direction of the upper securing frame 21.

In order to facilitate pushing and pulling of the foldable storage container, an inwardly depressed side-wall recess 31 is provided in each first side wall 3, and a handle 7 is rotatably arranged in the side-wall recess 31. Rotating shafts 71 are provided at two ends of the side-wall recess 31, which oppose in a widthwise direction of the first side wall 3, and the handle 7 is rotatably coupled at its ends to the rotating shafts 71. Within the side-wall recess 31, the handle 7 is vertically oriented under the effect of gravity without protruding beyond the end face of the first side wall 3.

It is to be noted that, as used herein, the term “hinged” refers to an articulated connection established with a hinge, which allow two hinged adjacent plates to be folded onto each other. For example, a number of side-wall individual plates 41 may be articulated with hinges so that they can be folded together to assume a reduced overall size.

Use of the present application is described below. In this example, the bottom wall 1, the surrounding first and second side walls 3, 4 and the top wall 2 together form a box defining an interior storage space. Prior to transportation, it is necessary to fold the foldable storage container.

At first, the first side walls 3 are folded by being pivoted about the first edges onto the bottom wall 1 so as to extend toward each other from the ends of the bottom wall 1 opposing in the lengthwise direction. The second side walls 4 are then folded. In this process, the side-wall individual plates 41 are first folded and then pivoted, as a whole, toward the bottom wall 1 onto the first side walls 3. As a result, the two second side walls 4 extend toward each other from the two sides of the bottom wall 1 opposing in the widthwise direction, and the top wall 2 resides on the second side walls 4. After that, the roller wheels 6 are stowed within the seat sleeves 5, or placed in a space between the top wall 2 and the bottom wall 1, completing the folding process.

In order to unfold the folded foldable storage container, the roller wheels 6 are first removed, and the top wall 2 may be lifted by some means so that the side-wall individual plates 41 are unfolded into the second side walls 4. When the second side walls 4 become upright, further movement of the top wall 2 is stopped. The first side walls 3 are then pivoted about the first edges, and when they are erected upright, adjacent first and second side walls 3, 4 are joined with connecting means. In this example, the side walls are joined using rivets. In this way, the first side walls 3 and the second side walls 4 are fixedly connected together and form, together with the top wall 2, a box defining an interior storage space. The roller wheels 6 are then securely mounted to the bottom of the bottom wall 1.

Therefore, according to the present application, when there is a need for transportation, the first side walls 3 and the second side walls 4 may be folded toward the bottom wall 1, converting the whole into a folded configuration. As a result, a reduced overall size is obtained, which occupies a smaller space during transportation, resulting in transportation cost savings. When there is a need for unfolding, the top wall 2 is directly pulled upwards so that the second side walls 4 become upright, and the first side walls 3 are then unfolded so as to also become upright. The first side walls 3 and the second side walls 4 are then joined together, completing the assembly of the whole structure. This provides the advantage of convenient assembly.

### Example 3

Referring to FIGS. 1 to 10, this example differs from Example 2 in that each first side wall 3 is provided in the form of a number of inter-hinged, foldable second individual plates. It is to be noted that, when folded, the second individual plates in each first side wall 3 have an aggregate thickness of d, and H2−H1≥d. This allows, after the first side walls 3 are folded onto the bottom wall 1, the second side walls 4 to be folded in turn onto the first side walls 3, without being affected by the first side walls 3.

### Example 4

Referring to FIGS. 1 to 10, this example is structurally similar to Example 1, 2 or 3, except that, in this example, the upper cover 22 is provided on its inner side with a first reinforcing web 81 extending in its lengthwise direction, which can increase the overall strength of the upper cover 22.

Moreover, the side-wall individual plates 41 are each provided on its inner side with a number of second reinforcing webs 82 juxtaposed in its lengthwise direction and extending in its widthwise direction. The second reinforcing webs 82 can increase strength of the side-wall individual plates 41.

In addition, the first side walls 3 are each provided on its inner side with two third reinforcing webs 83 juxtaposed in its widthwise direction above and below the side-wall recess 31.

Further, the lower cover 12 is provided on its inner side with a fourth reinforcing web 84 extending in its widthwise direction, which can increase strength of the lower cover 12. The first side walls 3 can be folded on opposite sides of the fourth reinforcing web 84, and the fourth reinforcing web 84 does not affecting the folding of the first side walls 3.

### Example 5

Referring to FIGS. 1 to 10, this example is structurally similar to Example 1, 2, 3 or 4, except that, in this example, a cable aperture 85 is provided in a second side wall 4. When out of use, the cable aperture 85 is sealed off with an aperture cap.

### Example 6

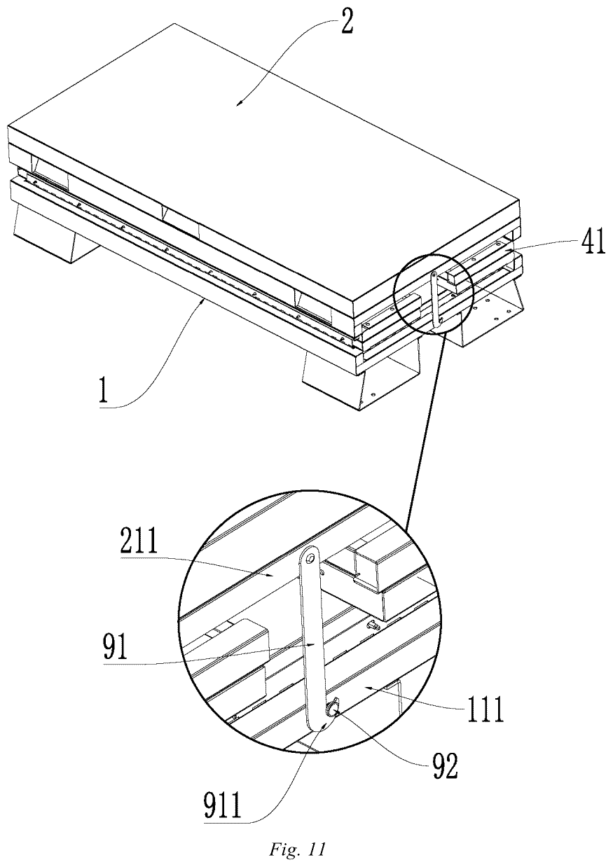

Referring to FIG. 11, this example is structurally similar to Example 1, 2, 3, 4 or 5, except that, in this example, a securing structure is provided between the top wall 2 and the bottom wall 1 to secure the top wall 2 and the bottom wall 1 against each other from any relative displacement therebetween after the box is folded. This can reduce vibration of the folded box and relative displacement of the top wall 2 and the bottom wall 1 during transportation and transfer.

In this example, the securing structure includes a rotatable plate 91 and a securing pin 92, which are arranged on the top wall 2 and the bottom wall 1, respectively. The rotatable plate 91 can be pivoted about a center of rotation and has a hook portion 911 at its end away from the center of rotation. Specifically, one end of the rotatable plate 91 is rotatably coupled to a second widthwise bar 211 of the upper securing frame 21 on an external side of the second widthwise bar 211. The securing pin 92 is fixed to a first widthwise bar 111 of the lower securing frame 11 also on an external side of the first widthwise bar 111. An end portion of the rotatable plate 91 away from the second widthwise bar 211 forms a hook portion 911. After the box is folded, the rotatable plate 91 can be pivoted to hook the securing pin 92 with the hook portion 911. A length of the rotatable plate 91 corresponds to a distance between the upper securing frame 21 and the lower securing frame 11 in the folded configuration of the box. With the hook portion 911 hooking the securing pin 92, the top wall 2 and the bottom wall 1 are secured against each other during transportation of the box. In this way, during transportation and transfer, less relative displacement will occur between the top wall 2 and the bottom wall 1, and the folded box stays more stably, makes less noise due to movement and overall suffers from less damage due to vibration.

Further, in this example, in order to enable the hook portion 911 to more firmly hook the securing pin 92, an inwardly recessed circular groove may be defined around a circumferential side wall of the securing pin 92.

Of course, it is also possible to rotatably couple the rotatable plate 91 to the first widthwise bar 111 of the lower securing frame 11 and fix the securing pin 92 to the second widthwise bar 211 of the upper securing frame 21.

Furthermore, two or four such securing structures may be arranged in symmetry at the opposite sides of the box opposing in the lengthwise direction to secure the two ends of the box opposing in the lengthwise direction, thereby providing better securing of the folded box.

### Example 7

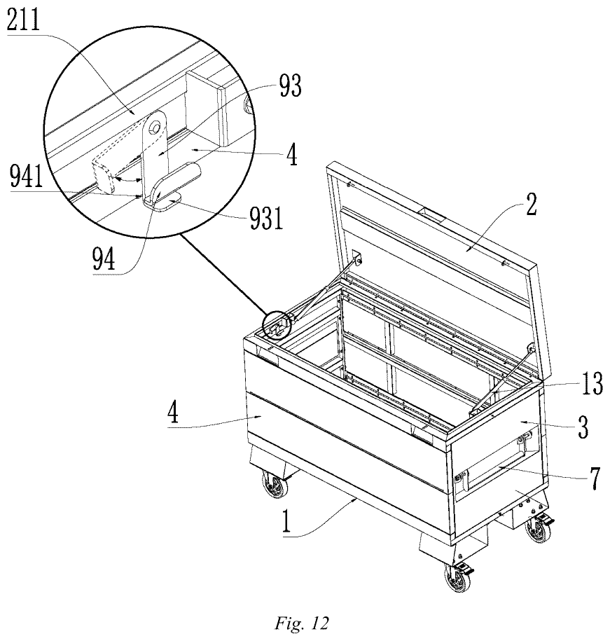

Referring to FIG. 12, this example is structurally similar to Example 1, 2, 3, 4 or 5, except that, in this example, instead of riveting the first side walls 3 and the second side walls 4 as described and illustrated in Example 1, 2, 3, 4, 5 or 6, which disallows easy restoration of the so-connected box to the folded configuration despite increased overall structural secureness thereof, connecting structures are arranged between the first side walls 3 and the top wall 2, or between the first side walls 3 and the second side walls 4. In the unfolded configuration of the box, the connecting structures can temporarily secure the first side walls 3 and the top wall 2 against each other. Moreover, in order to fold the box, the connecting structures can be disconnected, allowing separation of the first side walls 3 and the top wall 2. Thus, the box can be conveniently folded.

In this example, the connecting structures each include a connecting plate 93 and a locking plate 94, which are arranged on the top wall 2 and a first side wall 3, respectively. The locking plate 94 defines an open channel 941, and the connecting plate 93 defines a bent tab 931 at its end away from its center of rotation. The connecting plate 93 is pivotable and adapted to the open channel 941.

Specifically, in this example, each connecting structure includes a connecting plate 93 rotatably disposed on a second widthwise bar 211 and a locking plate 94 disposed on a first side wall 3. The locking plate 94 defines an open channel 941, and the connecting plate 93 defines a bent tab 931 at its end away from the second widthwise bar 211. The bent tab 931 is bent at an angle with respect to the rest of the connecting plate 93. In this example, the angle between the bent tab 931 and the rest of the connecting plate 93 is 90°. As shown in FIG. 12, in the unfolded configuration of the box, the connecting plates 93 are engaged in the open channels 941 (as indicated by the solid lines in FIG. 12) and thereby locked against the locking plates 94, connecting the first side walls 3 to the upper securing frame 21.

In order to convert the box from the unfolded configuration to the folded configuration, the connecting plates 93 may be pivoted away and disengaged from the open channels 941 (as indicated by the dashed lines in FIG. 12) and thereby unlocked from the locking plates 94, allowing the first side walls 3 and the second side walls 4 to be folded to convert the box into the folded configuration.

Further, as the connecting plates 93 are arranged on the second widthwise bars 211 and the locking plates 94 on the first side walls 3, the locking plates 94 are located under the connecting plates 93. In the unfolded configuration of the box, the connecting plates 93 are engaged in the open channels 941 and oriented vertically. In other words, in this configuration, the connecting plates 93 remain at the vertical orientation under the action of gravity. During use, except for manual intervention, the connecting plates 93 will not disengage from the open channels 941, ensuring that the box is always kept unfolded without affecting normal use. Only when the box is to be folded, the connecting plates 93 can be manually pivoted away and disengaged from the open channels 941 to allow the box to be folded. Additionally, according to the present application, the connecting structures are arranged inside the box. With this arrangement, when in the unfolded configuration of the box, the connecting structures inside the box can be effectively avoided from undesired touching of the connecting plates 93.

The above examples have been described merely as preferred embodiments of the present invention and are not intended to limit the invention in any sense. Other variations and modifications are also possible without departing from the scope as defined by the appended claims.

1. A foldable storage container, characterized in comprising a bottom wall and a top wall, the bottom wall hinged to first side walls and second side walls; both the first side walls and the second side walls are provided in two, and disposed in opposition at two sides of the bottom wall; the second side walls hinged to the top wall, the second side walls each comprising a number of inter-hinged side-wall individual plates, wherein when in a folded configuration, the side-wall individual plates are folded and the first side walls and the second side walls are folded by being pivoted about their edges, where they are hinged to the bottom wall, and stowed between the top wall and the bottom wall.

2. The foldable storage container according to claim 1, characterized in that the first side walls are hinged at their first edges to the bottom wall and that the second side walls are hinged at their second edges to the bottom wall, wherein the first edges are spaced from the bottom wall at a vertical height of H1, the second edges are spaced from the bottom wall at a vertical height of H2, the first side walls have a thickness of D, and H2−H1≥D.

3. The foldable storage container according to claim 1, characterized in that the bottom wall is provided at the bottom with a number of seat sleeves and a number of detachable roller wheels, the seat sleeves arranged along the two sides opposing in a widthwise direction of the bottom wall.

4. The foldable storage container according to claim 3, characterized in that the seat sleeves each comprise a first plate provided at opposite ends thereof respectively with a second plate and a third plate, wherein the roller wheels are detachably disposed at the bottom of the first plates.

5. The foldable storage container according to claim 3, characterized in that the first plates are disposed close to side edges of the bottom wall opposing in the widthwise direction and inclined toward the side edges of the bottom wall.

6. The foldable storage container according to claim 1, characterized in that the top wall comprises an upper securing frame and an upper cover, the upper cover hinged at a side edge on its one side to the securing frame.

7. The foldable storage container according to claim 6, characterized in that a support strut is provided between the upper securing frame and the upper cover and is connected to the upper securing frame at one end and to the upper cover at the other end.

8. The foldable storage container according to claim 6, characterized in that the upper securing frame are provided in its side wall with inwardly depressed locking recesses, on top of which there are locking plates defining locking slots extending therethrough, wherein the upper cover is provided with locking tongues in cooperation with the locking slots.

9. The foldable storage container according to claim 6, characterized in that the upper securing frame comprises two second widthwise bars and two second lengthwise bars, the two second widthwise bars disposed in opposition, the two second lengthwise bars also disposed in opposition, the two second lengthwise bars hinged to top ends of two second side walls, respectively, the second lengthwise bars having a greater height than the second widthwise bars.

10. The foldable storage container according to claim 9, characterized in that the second widthwise bars are each provided with a mounting protrusion having a number of mounting threaded holes arranged in a vertical row, wherein the upper cover is provided on its inner side with an inner cover plate, and the two ends of the support strut are respectively connected to the mounting threaded holes and the inner cover plate.

11. The foldable storage container according to claim 6, characterized in that the support strut is a hydraulic buffer strut comprising an oil cylinder and a piston rod movable at one end within the oil cylinder.

12. The foldable storage container according to claim 1, characterized in that the bottom wall comprises a lower securing frame and a lower cover fixedly connected to the lower securing frame, the lower securing frame comprising two first widthwise bars and two first lengthwise bars, the two first widthwise bars disposed in opposition, the two first lengthwise bars disposed in opposition, the first widthwise bars hinged to the first side walls, the first lengthwise bars hinged to the second side walls, the first lengthwise bars having a greater height than the first widthwise bars.

13. The foldable storage container according to claim 1, characterized in that the first side walls each have an inwardly depressed side-wall recess, in which a handle is rotatably disposed.

14. The foldable storage container according to claim 13, characterized in that rotating shafts are disposed at two ends of the side-wall recess opposing in a widthwise direction of the first side wall, wherein opposite sides of the handle are rotatably coupled to the rotating shafts at said two ends, respectively.

15. The foldable storage container according to claim 1, characterized in that a securing structure is provided between the top wall and the bottom wall to secure the top wall and the bottom wall against each other in the folded configuration of the box to limit relative displacement of the top wall and the bottom wall.

16. The foldable storage container according to claim 15, characterized in that the securing structure comprises a rotatable plate and a securing pin, which are disposed on the top wall and the bottom wall, respectively, the rotatable plate having a hook portion at its end away from a center of rotation.

17. The foldable storage container according to claim 1, characterized in that connecting structures are provided between the first side walls and the top wall to temporarily secure the first side walls against the second side walls or the top wall in an unfolded configuration of the box.

18. The foldable storage container according to claim 17, characterized in that the connecting structures each comprise a connecting plate and a locking plate, which are arranged on the top wall and the first side walls, respectively, the locking plate defining an open channel, the connecting plate able to be pivoted and adapted to the open channel.

19. The foldable storage container according to claim 18, characterized in that the locking plate is located under the connecting plate.

20. The foldable storage container according to claim 18, characterized in that the connecting plate defines a bent tab at its end away from a center of rotation.
